(19) United States
(12) Patent Application Publication
(10) Pub. No.: US 2021/0303331 A1
(43) Pub. Date: Sep. 30, 2021

(54) ENHANCED DESCRIPTORS SYSTEMS AND PROCESSES

(71) Applicant: 10518590 CANADA INC. (LES SERVICES LASTCARD), Montréal (CA)

(72) Inventors: Alexander MARTIN-BALE, Montréal (CA); Daniel ASSOULINE, Montréal (CA)

(21) Appl. No.: 17/214,279

(22) Filed: Mar. 26, 2021

Related U.S. Application Data
(60) Provisional application No. 63/002,421, filed on Mar. 31, 2020.

(51) Int. Cl. G06F 9/455

(52) U.S. Cl. CPC G06F 9/45558

(57) ABSTRACT

Processes and systems for enhanced descriptors via virtual machines is provided. A process may include: upon receipt of a first request relating to authorization of an action on a virtual instrument and comprising a first descriptor, computing, by a virtual machine, client preferences linked with the virtual instrument; generating, by the virtual machine, a second descriptor that is different than the first descriptor, the second descriptor generated based at least in part on the client preferences; and transmitting, by the virtual machine, a second request relating to authorization of the action on an origin instrument linked with the virtual instrument and comprising the second descriptor.

### RELATED APPLICATION

The present application claims the benefit of U.S. Provisional Application No. 63/002,421 filed Mar. 31, 2020, the entire disclosure of which is hereby incorporated by reference in its entirety.

### FIELD

The present disclosure relates to virtual or proxy instruments, and more specifically to systems and processes for enhanced descriptors for use with the same.

### SUMMARY

According to an aspect, a process for enhanced descriptors via virtual machines is provided. The process comprises: upon receipt of a first request relating to authorization of an action on a virtual instrument and comprising a first descriptor, computing, by a virtual machine, client preferences linked with the virtual instrument; generating, by the virtual machine, a second descriptor that is different than the first descriptor, the second descriptor generated based at least in part on the client preferences; and transmitting, by the virtual machine, a second request relating to authorization of the action on an origin instrument linked with the virtual instrument and comprising the second descriptor.

In a possible embodiment, the process comprises receiving, by the virtual machine, received client preferences from a device, the received client preferences setting descriptor control logic to link with the virtual instrument; and linking the received client preferences with the virtual instrument in a client preferences memory.

In a possible embodiment, the process comprises receiving, by the virtual machine, a request from the device to adapt the received client preferences linked with the virtual instrument to define new descriptor logic; and adapting the received client preferences in the client preferences memory to use the new descriptor logic.

In a possible embodiment, the first request comprises an instrument number, and computing client preferences comprises identifying the received client preferences linked with the instrument number in the client preferences memory.

In a possible embodiment, the process comprises receiving, by the virtual machine, a request from a device to generate the virtual instrument linked with the origin instrument, the request including client preferences delineating descriptor logic; generating, by the virtual machine, a unique instrument number for the virtual instrument; storing the unique instrument number in a virtual instrument information memory linked with the origin instrument; and storing the received client preferences in a client preferences memory linked with the virtual instrument.

In a possible embodiment, the process comprises storing, by the virtual machine, an indication of the first request in a memory, the indication of the first request comprising at least the first descriptor.

In a possible embodiment, the process further comprises storing, by the virtual machine, an indication of the second request, the indication of the second request comprising at least the second descriptor and the indication of the first request.

In a possible embodiment, the client preferences delineate descriptor control logic to be applied to a specified action type, the process further comprising computing whether the first request relates to the specified action type, and generating the second descriptor using the descriptor control logic if the first request relates to the specified action type.

In a possible embodiment, the process further comprises generating the second descriptor using predefined default descriptor logic if the first request does not relate to the specified action type.

In a possible embodiment, the client preferences delineate at least first descriptor control logic linked with a first action type and a second descriptor control logic linked with a second action type, the process further comprising determining whether the first request relates to the first action type or the second action type and generating the second descriptor using the descriptor control logic linked with the computed action type.

In a possible embodiment, the descriptor logic comprises a predefined string, further wherein the second descriptor is generated to include the predefined string.

In a possible embodiment, the predefined string is received from a device when computing the client preferences.

In a possible embodiment, the predefined string comprises variables; and upon generation of the second descriptor, the predefined string variables are replaced.

In a possible embodiment, the process comprises generating a unique action identifier, wherein the second descriptor is generated to include the predefined string.

In a possible embodiment, generating the second descriptor comprises prepending, appending or inserting additional characters into the first descriptor.

In a possible embodiment, the process comprises authenticating the request relating to authorization of the action on the virtual instrument using authorization logic, and transmitting the second request relating to authorization of the action on the origin instrument if the request relating to authorization of the action on the virtual instrument is successfully authenticated.

According to an aspect, a system for enhanced descriptors comprising a virtual machine configured to upon receipt of a first request relating to authorization of an action on a virtual instrument, the first request comprising a first descriptor, compute client preferences linked with the virtual instrument; generate a second descriptor that is different than the first descriptor, the second descriptor being generated using descriptor control logic defined in the client preferences; and transmit a second request relating to authorization of the action on an origin instrument linked with the virtual instrument, the second request comprising the second descriptor.

### BRIEF DESCRIPTION OF THE DRAWINGS

FIG. 1 is a block diagram illustrating a system for providing enhanced descriptors, according to an embodiment.

FIG. 2 is a flowchart illustrating a process for providing enhanced descriptors, according to an embodiment.

FIGS. 3A and 3B are flowcharts illustrating a process for action authorization that can employ enhanced descriptors, according to an embodiment.

### DETAILED DESCRIPTION

As will be described in more detail hereinafter, the present disclosure relates to transaction flows that allow payments to be carried out using proxy payment processes. Such payment methods can allow clients to proceed with electronic transactions without having to provide their actual payment information (such as their origin credit card number or other origin banking details). Instead, the customer need only provide the proxy payment details, with the client's actual payment information being hidden from the merchant.

It should be appreciated that different proxy payment methods are possible. For example, in some embodiments, the proxy payment method can comprise a proxy credit card. Such a payment method can provide an interface allowing merchants to authorize transactions in the same manner they would with a traditional credit card. However, the proxy credit card would be linked to one or more other payment methods (such as an origin credit card, origin bank account, etc.) In some embodiments, the proxy credit card can be physical, while in other embodiments, the card can be virtual in that the card is created by generating a unique card number without a physical card associated herewith. For simplicity throughout the present disclosure, embodiments will be described in connection with virtual credit cards. It should be appreciated, however, that the teachings can apply to other proxy payment methods as well.

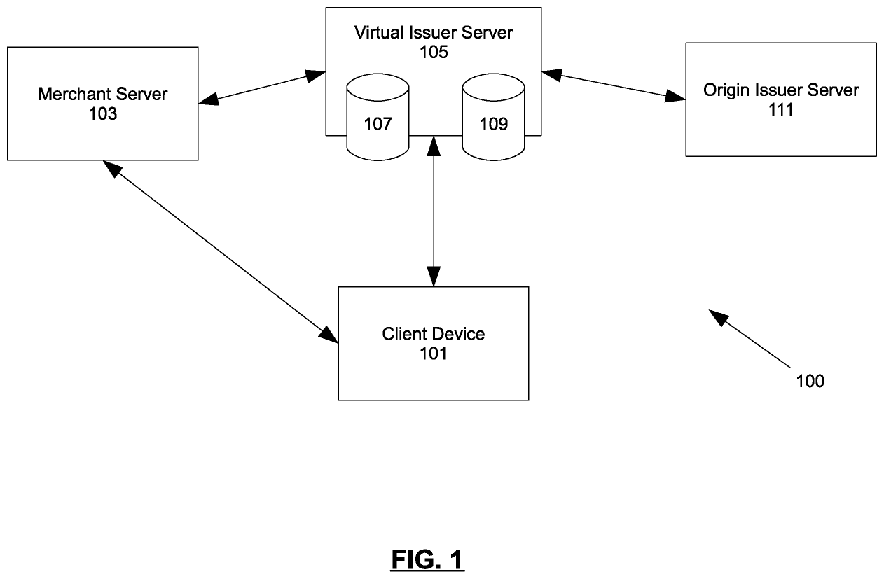

With reference to FIG. 1, a system 100 for providing enhanced descriptors for electronic purchases is shown according to an embodiment. In the illustrated embodiment, the system 100 comprises a client device 101, a merchant server 103, a virtual issuer server 105, and an origin issuer server 111 in communication with one another. It should be appreciated that these devices can communicate with one another by different means, for example via a direct communication link, via a network link and/or over the internet. It will further be appreciated that the merchant server, virtual issuer server, and/or origin issuer server may be referred to herein as a merchant machine, virtual machine, and/or origin machine, respectively.

The client device 101 is associated with a client (also referred to herein as a customer), and generally provides the client with means to initiate an electronic transaction such as an electronic purchase transaction to pay for products or services offered to the client by a merchant. The client device 101 can comprise one or more computing devices that can be operated by the client to initiate the electronic purchase transaction (electronic purchase transactions may be referred to herein as an “action” or the like). By way of example, the client device 101 can comprise a personal computer, laptop, smartphone, tablet, smartwatch, smart payment card, and/or any other type of device that is programmable or configurable to initiate an electronic purchase transaction.

In the present embodiment, the client device 101 is configured to request that a payment be carried out using a prepaid virtual credit card associated with the client. The client device 101 can thus be configured to provide a reference to the virtual credit card to the merchant, for example by supplying a card number and/or account information associated therewith. The client device 101 need not provide such information directly. For example, the client device 101 can be in communication with another entity or computing device (such as a digital wallet platform) that can provide the required information to the merchant. It should be appreciated that in some embodiments, the client device 101 can initiate a transaction locally, for example via contactless payment at a payment terminal operated by a merchant, and/or remotely, for example via a website through a web-browser or via an in-app purchase that is in communication with a remote merchant.

The merchant server 103 is associated with a merchant and generally provides the merchant with functionality to complete a sale of a product or service. The merchant server 103 can comprise one or more servers configured to offer products or services to clients and/or to accept corresponding payments via a credit card or other electronic payment method. The merchant server 103 can be configured to accept payments locally or remotely. By way of example, the merchant server 103 can be associated with a point-of-sale (POS) system and/or a payment terminal for completing a retail transaction and accepting card payments. As another example, the merchant server 103 can comprise a webserver implementing an online e-commerce store for offer products for sale and implementing a payment gateway for accepting card payments online.

The merchant server 103 can also be associated with a merchant acquirer that is configured to handle communications with an issuing bank (or virtual issuer) to process card payments. For simplicity throughout the present disclosure, the merchant server 103 will refer to a server or group of servers that can handle communications with an issuing bank, whether that is done directly by the merchant or through a merchant acquirer. To this effect, it should be appreciated that the merchant server 103 can comprise one or more servers controlled by different entities. For example, the merchant server 103 can comprise a webserver operated by the merchant that implements an e-commerce store, and/or an acquirer server operated by a merchant acquirer for handling communications with issuing banks to process card payments. Moreover, for simplicity throughout the present disclosure, when communications are said to be transmitted by or received from a merchant, it is understood that the communications need not be sent directly to or received directly from the merchant. Instead, those communications can be sent and/or received via an intermediate party which can facilitate or enable such communications, such as a merchant acquirer among others.

The virtual issuer server 105 is associated with an issuer of virtual credit cards (such as a virtual bank), and generally provides the issuer with functionality to implement virtual credit cards. For example, the virtual issuer server 105 can comprise one or more servers configured to generate virtual cards on demand (for example following a request from client device 101). The one or more servers can further be configured to receive, process, and respond to authorization requests received from the merchant server 103 (for example via a merchant acquirer server associated with a merchant acquirer).

The virtual issuer server 105 can respond to authorization requests by approving or denying transactions. As can be appreciated, upon receipt of a payment authorization request (such as through a credit card network or issuing partner), the virtual issuer server 105 can perform various actions to determine whether to generate an approval or denial message for ultimately returning to the merchant server 103. Among these actions, the virtual issuer server 105 may need to approve transactions via an origin payment method associated with a virtual card. Accordingly, the virtual issuer server 105 can also be associated with a virtual acquirer that is configured to handle communications with an origin bank to authorize charges to the origin payment method. For simplicity throughout the present disclosure, the virtual issuer server 105 will refer to a server or group of servers that can handle communications with an issuing bank, whether that is done directly by the virtual issuer or through a virtual acquirer. To this effect, it should be appreciated that the virtual issuer server 105 can comprise one or more servers controlled by different entities. For example, the virtual issuer server 105 can comprise a first server operated by the virtual issuer for conducting initial transaction authorization logic, and/or a virtual acquirer server operated by a virtual acquirer for handling communications with issuing banks to authorize and process payments through an origin payment method (such as an actual credit card or bank account). Moreover, for simplicity throughout the present disclosure, when communications are said to be transmitted by or received from a virtual issuer, it is understood that the communications need not be sent directly to or received directly from the virtual issuer. Instead, those communications can be sent and/or received via an intermediate party which can facilitate or enable such communications, such as a virtual acquirer, a credit card network, issuing partner, etc.

The origin issuer server 111 is associated with an issuer of an origin card (such as an origin bank), and generally provides the origin issuer with functionality to authorize transactions through an origin payment method. For clarity, an origin issuer corresponds (or relates) to an entity that provides payment methods directly to a client, such as through an actual credit card, debit card, prepaid card, etc. The origin issuer server 111 can be configured to receive, process and respond to authorization requests form the virtual issuer server 105 (for example via a virtual acquirer). The origin issuer server 111 can perform various actions to determine whether to generate an approval or denial message for returning to the virtual issuer server 105, for example including determining whether sufficient funds are available via the origin payment method. As used herein, “determining” or “determine” and “computing” or “compute” may be used synonymously.

In the above-described configuration, the virtual issuer server 105 essentially acts as an intermediary between the merchant server 103 and the origin issuer server 111. This adds a layer of security, as the merchant server does not have access to the client's origin payment information. Instead, this sensitive information can be stored securely on the virtual issuer server 105, or alternatively the storage of sensitive information can be avoided using tokenization of the origin payment information. The client can thus maintain control over what is ultimately charged to their origin payment method by using the virtual issuer server 105 as a gatekeeper.

The above-described configuration further allows providing enhanced functionality and features that may not otherwise available through the client's origin payment method. For example, clients can be provided with more detailed, meaningful and/or enriched transaction information via the virtual issuer server 105. Virtual credit cards generated by the virtual issuer server 105 can further allow to more easily organize transactions that are eventually charged to one or more origin payment methods. For example, the virtual issuer server 105 can allow generating purpose-specific virtual cards. Such cards can be generated by clients on demand, for example following a request from the client device 101 to the virtual issuer server 105. Transactions applied to one purpose-specific virtual credit card can be grouped and reported differently than transaction applied to another purpose-specific virtual credit card. Transactions can also be treated differently on each purpose-specific virtual credit card, for example with client-defined transaction limits, authorized transaction types, etc.

As can be appreciated, there are different types of purpose-specific virtual credit cards that can be generated. By way of example, a purpose-specific card can correspond to a transaction-specific card. In an embodiment, a transaction-specific card can be a one-time use card that is generated specifically for a given transaction. A client can generate a one-time use virtual credit card before proceeding with a transaction (for example a purchase on an e-commerce website). The virtual issuer server 105 can be configured to process a first transaction applied to the one-time use card, while refusing subsequent transactions applied to the card.

In other embodiments, a transaction-specific card can be a card that is generated specifically for transactions of a given type, such as transactions from one or more specified merchants, websites, application, subscriptions, services, etc. The virtual credit card can be associated (e.g., linked) with the transaction type such that the virtual issuer server 105 is configured to process only those transaction types on the virtual credit card, while refusing other types of transactions that are applied to the card. It should be appreciated that a transaction-specific card can also be one-time use.

As another example, a purpose-specific card can correspond to a wallet-type card. Such cards can be generated specifically for use with one or more digital wallets. For example, a client can generate a virtual card for use exclusively with the Google Pay digital wallet, and the virtual issuer server 105 can be configured to only process transactions on the virtual card if they are charged through Google Pay. Similar card can be generated for other digital wallet types, such as Apple Pay, Samsung Pay, etc.

As a further example, a purpose-specific card can correspond to a delegate card. Such cards can be generated specifically for use by a particular individual and/or for a specific purpose to provide delegated access to the client's origin payment method. For example, a client can generate a virtual card for use by an employee for business-related expenses. Transactions charged through this card can be grouped and identified, such that the client can more easily distinguish business-related expenses from other charges to their origin payment method.

As yet another example, a purpose-specific card can correspond to a partner-branded card. Such cards can be generated specifically for use with products or services provided by a predefined partner. In such an example, a card can be generated for processing transactions on one or more of the partner's software applications or websites. Transaction charged through this card can be grouped and identified, such that the client can more easily identify transactions carried out through the partner.

Although some examples of purpose-specific cards have been described, it should be appreciated that other purpose-specific card types are possible. Moreover, although some advantages and uses of virtual cards have been described, it should be appreciated that other advantages and applications are possible as well.

As mentioned above, the virtual issuer server 105 allows providing enhanced features and functionality through virtual credit cards that may not be available to clients through their origin payment method. In the present embodiment, the virtual issuer server 105 is configured to allow clients to control how transaction descriptors ultimately appear on statements from their origin issuer.

As can be appreciated, purchases to conventional credit cards are typically identified to a cardholder by a 25-character transaction descriptor that appears on their statement. The descriptor usually carries some kind of identification of the merchant or purchase (such as the merchant name, location, phone #, description, URL, etc.) The goal is to provide the cardholder with a description of the purchase for identification on a statement. In the present embodiment, the virtual issuer server receives a transaction authorization request from the merchant server 103 that includes a transaction identifier. Before passing on the transaction authorization to the origin issuer, the virtual issuer server 105 uses descriptor control logic to modify (e.g., adapt), append, prepend or replace the descriptor provided by the merchant server 103, such that the descriptor ultimately appearing on a statement associated (e.g., linked) with the origin card is defined by the virtual issuer server 105 instead of the merchant server 103. Depending on the descriptor logic, a descriptor generated by the virtual issuer server 105 can be different than a descriptor that was initially received as part of a transaction authorization request from the merchant server 103.

Clients can control the descriptor control logic via client preferences associated (or related to) with one or more virtual cards. In the illustrated embodiment, a client preferences database 107 is associated with the virtual issuer server 105 for storing the client preferences. The client preferences database 107 is persistent storage local to the virtual issuer server 105, although it is appreciated that the database 107 can comprise other storage means and/or can be remote while accessible to the virtual issuer server 105. It should be appreciated that the client preferences can be defined by clients, for example via one or more of their client devices 101 that is in communication with the virtual issuer server 105. Using software on the client device 101 (such as on a website on a web browser, or through a dedicated application), the client device 101 can send a request to the virtual issuer server 107 to set a client preference for one or more virtual cards. In response thereto, the virtual issuer server 107 can store the client preference in the client preferences database 107 in association with the one or more virtual cards. The client preferences can be defined, for example, at the same time that the client device 101 sends a request to the virtual issuer server 107 to generate a virtual card, or at any time thereafter. When the virtual issuer server 107 subsequently receives an authorization request from the merchant server 103 to authorize a transaction on a given virtual credit card, the virtual issuer server 107 will apply the appropriate descriptor logic to generate a descriptor based on the client preferences associated with the given virtual credit card.

Although the client preferences were described above as being associated with one or more virtual cards, it should be appreciated that the client preferences can also be associated with a particular transaction type. For example, for two transactions of a different type on the same virtual credit card, the virtual issuer server 107 can apply different descriptor logic to generate two descriptors differently, based on the client preferences associated with each transaction type. The type of a transaction can correspond to whether the transaction is a purchase, pre-authorization, capture, void, refund, verification, etc. The type can also be defined by different transaction-specific parameters, such as the identity of the merchant initiating the transaction, the product or service being purchased, whether the transaction is a one-time charge or a recurring charge, whether the transaction was initiated through a website, an application, or through a store terminal, etc. Moreover, it should be appreciated that the client preferences can define (e.g., delineate) default descriptor logic that applies to all transactions unless overridden by other client preferences. Accordingly, when the virtual issuer server 107 receives an authorization request from the merchant server 103 to authorize a transaction, the virtual issuer server 107 can determine whether the transaction corresponds to a transaction type for which client preferences have been defined (e.g., delineated). In the affirmative, the virtual issuer server 107 can generate a descriptor using descriptor logic based on the client preference associated with that transaction type and forward an authorization request to the origin issuer server 111 using the generated descriptor.

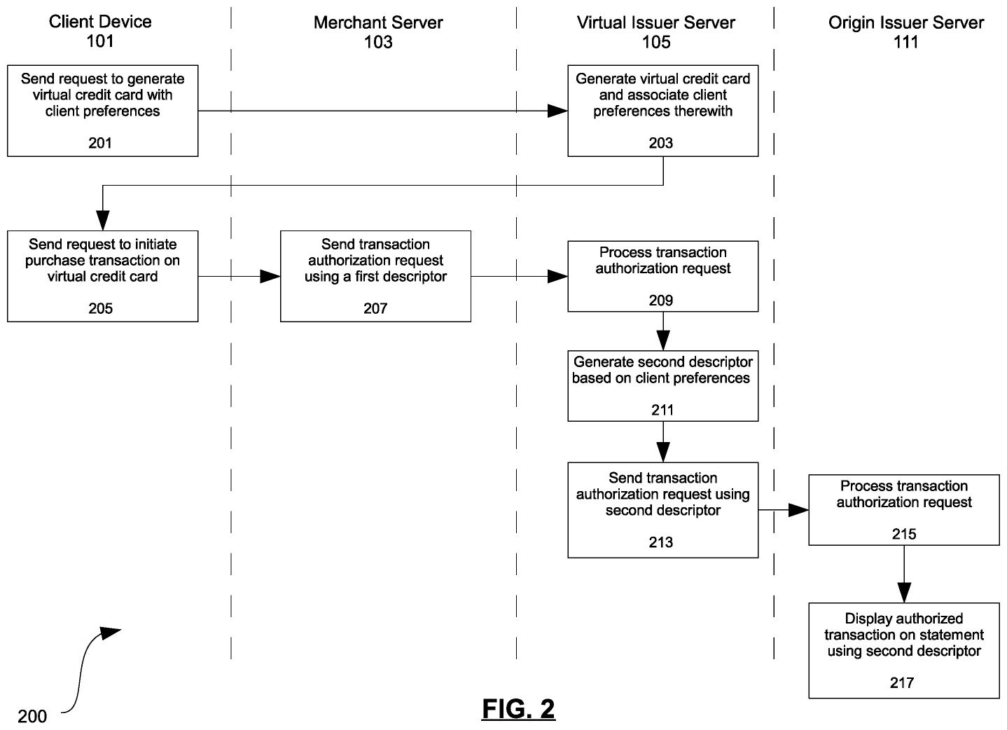

With reference now to FIG. 2, an exemplary method 200 of providing enhanced descriptors is shown according to an embodiment. A first step 201 comprises sending a request from a client device 101 to generate a virtual credit card with client preferences. This step can be carried out, for example, following receipt of a corresponding input from a client on the client device 101 using software running on the client device 101 such as through a website, web browser plugin, software application, etc. The input can include client preferences to define the descriptor logic behavior associated with the card.

At a next step 203, the request from the client device 101 is received at the virtual issuer server 105 and, in response thereto, the virtual issuer server 105 generates the virtual credit card and associates client preferences therewith. The client preferences received from the client device can be stored, for example, in the client preferences database 107 described above. As can be appreciated, the virtual credit card being generated can be a purpose-specific card as specified by the client, such as a one-time use card, a transaction-specific card, a wallet-type card, a delegate card, a partner-branded card, etc. as described above. The virtual credit card can further be associated with one or more of the client's origin payment methods, such as an origin credit card, bank account, etc. Although not illustrated, it is appreciated that after the card is created, subsequent requests can be received from the client device 101, for example to update or change client preferences of a previously generated card, change the card type/purpose, disable the card, update or change the associated origin payment methods, etc.

Once the virtual credit card has been generated, it can be used by the client to pay for purchases just like any normal credit card. Accordingly, a subsequent step 205 can include sending a request to a merchant to initiate a transaction on the virtual credit card. To carry out this step, the client can use a client device 101 to provide the merchant with payment information corresponding to the virtual credit card. For example, this can involve providing the merchant with the virtual credit card number and/or any other reference to the virtual credit card (such as through a payment service or digital wallet). The virtual credit card information can be provided using different devices and different methods, such as via contactless payment at a payment terminal (ex: using a smartphone, smart watch, or smart card), via a fillable form on an e-commerce website or in-app purchase, via a physical proxy card, etc. Although in the present embodiment the card is generated and used by the same client, it is appreciated that other configurations are possible. For example, a request to create a virtual card can be sent via a first client device controlled by a first user (such as by an administrator), and a request to initiate a transaction can be sent by a second client device (and/or other transaction initiating methods) controlled by a second user (such as by a delegate).

In step 207, the merchant server 103 receives the request for the client device 101 and sends a first transaction authorization request to the virtual issuer server 105 to authorize the transaction on the virtual credit card. As can be appreciated, the merchant server 103 can send this authorization request to the appropriate virtual card issuer via a merchant acquirer server, through the appropriate credit card network (such as via the Visa, Mastercard, or Europay networks) and/or via an issuing partner. This authorization request will include various information associated with the transaction, including a first transaction descriptor. The first descriptor is generated by the merchant acquirer which, as part of the present example, is part of the merchant server 103. The first descriptor can include information relating to the merchant and/or the product or service being purchased so that the transaction can be subsequent identified by the client in a statement or other report. In the present example, the first descriptor is a string “XXXXXXX”.

In step 209, the virtual issuer server 105 receives the transaction authorization request from the merchant server 103 (which can be through one or more intermediate parties such as a merchant acquirer, credit card network, issuing partner, etc. and their corresponding servers) and can subsequently process the authorization request according to authorization logic associated with the virtual credit card. For example, the virtual issuer server 105 can determine if the authorization request corresponds to a transaction that is permitted on the virtual credit card (such as a specific transaction, a specific category of transaction, a specific merchant, etc. as defined by the client when configuring the virtual credit card). In the negative, the virtual issuer server 105 can refuse the transaction outright, without needing to authorizer the transaction through the origin payment method. It should be appreciated that the virtual issuer server 105 can carry out other authorization logic, such as fraud detection. Examples of authorization logic and corresponding methods are described in more detail hereinbelow, and in the applicant's co-pending application U.S. Ser. No. 15/372,533, published as US 2017/161742, the entirety of which is incorporated herein by reference. As can be appreciated, transaction authorization requests through payment networks or issuing partners can be time limited. Accordingly, the virtual issuer will need to respond to authorization requests within a predefined time window (such as 5 seconds), otherwise the transaction will be cancelled.

If the transaction is not outright refused, the virtual issuer server 105 (for example acting as a virtual acquirer) can determine whether the transaction corresponds to a transaction for which client preferences have been defined, and generate a second descriptor in step 211. The second descriptor generated in this fashion can be based on the client preferences associated with the virtual credit card and/or associated with the specific transaction or transaction type. This second descriptor can be different then the first descriptor. As an example, the second descriptor can be a string “YYYYYYY”. As will be described in more detail hereinafter, this second descriptor can be generated such that it anonymizes or obfuscates the transaction, allows to more easily identify the transaction, provides a more pertinent description of the transaction, etc. It should also be appreciated that the second descriptor can be generated using information derived from the first descriptor and/or any other information available to the virtual issuer server 105 (such as information about the transaction, client, merchant, among others).

After the second descriptor is generated, a subsequent step 213 can comprise sending a second transaction authorization request to one or more origin payment methods associated with the virtual credit card. This second transaction authorization request can be sent by the virtual issuer server 105 acting as a virtual acquirer and includes the second descriptor as part of the transaction information. It is appreciated that the authorization request can be forwarded to the origin issuer server 111 via one or more intermediate parties, such as the virtual acquirer, credit card network and/or origin issuing partner (if applicable). As can be appreciated, the steps of generating the second descriptor and sending the second transaction authorization request should be carried out before the expiration of any predefined time window imposed by a payment network and/or issuing partner, in order to give enough time to receive a response from the origin issuer server 111 and subsequently respond to the merchant server within the predefined time window. Preferably, the steps of generating the second descriptor and sending the second transaction authorization request are carried out as soon as possible. For example, such steps can be carried out prior to carrying out authorization logic steps, such as fraud detection. In other examples, such steps can be carried out simultaneously and/or in parallel with authorization logic steps.

Next, in step 215, the origin issuer server 111 receives the second authorization request and processes it as usual (for example as if receiving an authorization request directly from a merchant instead of via a virtual issuer). This can involve determining if there are sufficient funds in the origin payment method and/or conducting additional authorization analysis, such as fraud analysis.

If the transaction is authorized, the transaction will be applied to the client's origin payment method. In step 217, the transaction can be reported to the client, for example as part of a monthly account statement or other interface that allows the client to consult transactions through the origin issuer. When the transaction is displayed in this manner, it will be identified using the second descriptor “YYYYYYY” that was supplied by the virtual issuer server 105, instead of the first descriptor “XXXXXXX” that was provided by the merchant server 103.

Although not illustrated, it is appreciated that depending on the outcome of the transaction at the origin issuer server 111, an approval or denial message can be sent to the virtual issuer server 105, and a corresponding approval or denial message can be propagated by the virtual issuer server 105 back to the merchant server 103 to provide an indication of whether or not the transaction is approved or denied. A corresponding indication can be displayed on the client device 101 and/or any other equipment used to interact with the client such as a payment terminal. The approval or denial message can be transmitted by the virtual issuer server 105 within any predefined time window imposed by the payment network and/or issuing partners.

Moreover, it is appreciated that the virtual issuer server 105 can maintain a record (e.g., indication) of transaction requests and/or approved transactions. Such records (e.g., indications) can be stored in a transaction database 109 associated with the virtual issuer server 105. The transaction database 109 is persistent storage local to the virtual issuer server 105, although it is appreciated that the database 109 can comprise other storage means and/or can be remote while accessible to the virtual issuer server 109. The transaction database 109 can store detailed transaction information, such as the original merchant, originating website or payment terminal location, original descriptor, etc. This detailed information can be accessed by clients using their client device 101. The transaction database 109 can further maintain a correlation between transaction requests received from the merchant server 103, and transaction requests/authorizations subsequently forwarded to the issuer server 111. This can include a correlation between the first descriptor and the second descriptor, thus allowing clients to search for and/or recover the original transaction (including any corresponding detailed information) using the second descriptor that appears on their origin payment method statement.

Enhancing descriptors according to the method described above allows the client to control how transactions ultimately appear on their origin statement. This can be applied in a number of different use cases and provide numerous advantages. As a first example, the method can be used to anonymize or obfuscate transactions appearing on the client's origin statement. As can be appreciated, a client may not want certain transactions to be identifiable to a third party on their origin statement. Accordingly, the client can generate a virtual credit card through the virtual issuer server 105 while designating that card as an anonymous card through the client preferences. In such a configuration, all transactions applied to the virtual card will be designated as anonymous, and the descriptor logic will generate a descriptor accordingly. In some embodiments, the client can configure the virtual card such that only certain types of transactions (such as transactions for a particular product, from a particular merchant, etc.) applied to that card are designated as anonymous.

To anonymize a transaction, the second descriptor generated by the virtual issuer server 105 in step 211 can omit or hide any information that can potentially identify the transaction. To do so, the second descriptor can be generated without using any information from the first descriptor. By way of example, the generated second descriptor can correspond to a predefined string, such as a string provided by the user, a default string defined by the virtual issuer (such as “PAYAWARE”), or simply a randomly generated string. The descriptor generated in this fashion can be static or can have a dynamic component (such as “PAYAWARE*9999”, where “9999” is a random number or ID). In some embodiments, the second descriptor can comprise encrypted information corresponding to the first descriptor and/or detailed transaction information, with the encrypted information being decryptable using a key provided by the client and/or stored on the virtual issuer server 105.

As another example, the method can be used to more easily identify transactions appearing on a statement. As can be appreciated, descriptors provided by merchants may not be optimal for searching or filtering. Accordingly, the client can generate a virtual credit card configured with descriptor logic that inserts an identifier into the descriptors it generates. In some embodiments, the descriptor logic can be configured such that for all transactions processed on the virtual card (or specific transaction types), the second descriptor is generated by prepending, appending or replacing the first descriptor with a unique identifier (UID). The client can subsequently use the UID to more easily search and identify each transaction. In some embodiments, the descriptor logic can be configured to prepend, append or replace the first descriptor with an identifiable string provided by the client. This can be used to group or distinguish categories of transactions appearing on a statement. For example, all purchases on a delegate card can be prepended with the delegate's name (such as “DELEGATE*XXXXX”, where “XXXXX” is the original first descriptor, or a portion thereof), allowing to more easily separate delegate transactions from other transactions. As another example, all purchases on a partner-branded card can be prepended with the partner's name (such as “PARTNER*XXXXX”, where “XXXXX” is the original first descriptor, or a portion thereof), allowing to more easily identify transactions through a particular partner.

Finally, the method can be used to provide more pertinent descriptions of transactions appearing on a statement. As can be appreciated, descriptors generated by merchants can often be cryptic and it can be difficult to understand at a glance exactly what was purchased. To address this, the client can generate a virtual credit card configured with descriptor logic that provides a more explicative descriptor. For example, before proceeding with a transaction, the client can generate a one-time use card and configure the card such that the transaction applied to that card is replaced with a specific descriptor that explains the transaction (such as “Digital Camera” for the purchase of a camera at an online retailer). In some embodiments, the system can recognize that a one-time use card was generated while the user was visiting a particular website (such as via a browser plugin) or using a particular service, and can automatically replace the descriptor with one that corresponds to that website or service (such as “website.com”). In further embodiments, the system can maintain a database of descriptors used by different merchants in order to recognize charges from those merchants and provide more explicative descriptors.

As another example, the client can define a custom descriptor structure for all transactions applied to that card. The structure can be defined using wildcard characters and/or variables that can be replaced with transaction-specific information (such as “<city>*<merchant>” where <city> is automatically replaced by the city where the transaction took place, and <merchant> is replaced by the merchant name). In this configuration, the transaction can be displayed in any format that the client desires.

Finally, descriptors can be made more pertinent by stripping information that is less relevant to the client. For example, all transactions through Google Pay are generally identified as “GPAY*XXXX” where “XXXX” is the app developer's name. To make such a descriptor more relevant, a second descriptor can be generated by stripping “GPAY*” from the first descriptor and/or replacing it with other information as defined by the client preferences.

Although exemplary use cases have been described, it is appreciated that other use cases are possible as well. It is also appreciated that embodiments of the described use cases can be combined if desired. The examples provided above are for illustrative purposes only, and should not be taken to limit the scope of the invention.

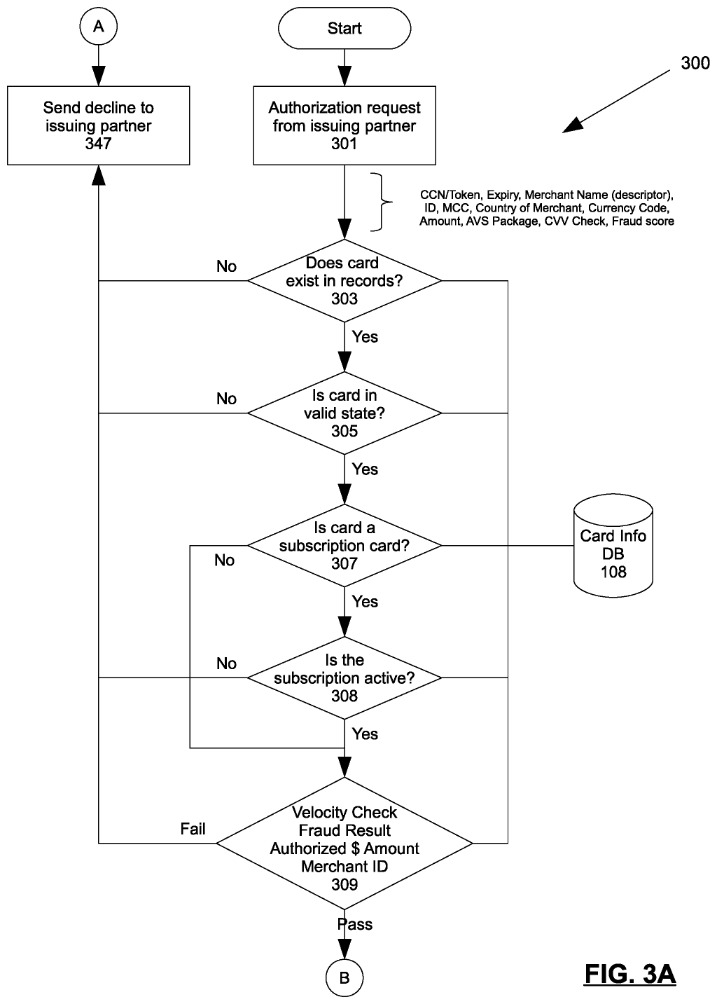

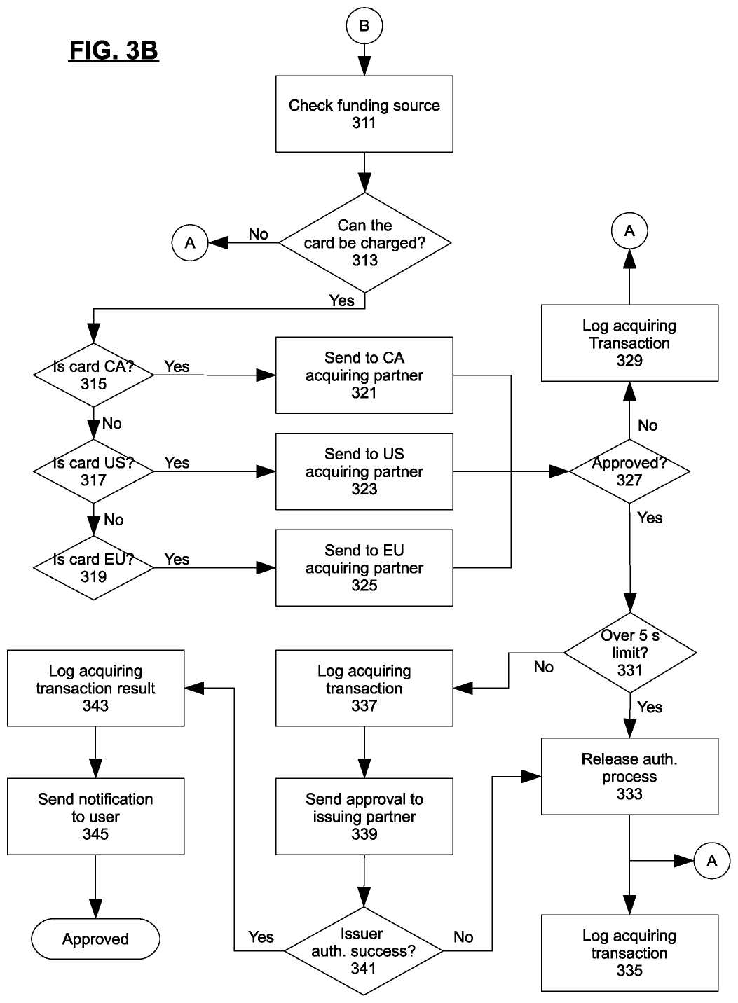

As briefly described above, the method for providing enhanced descriptors can form part of a more complete transaction authorization process which involves transaction authorization logic at the virtual issuer and/or at the origin issuer server. By way of example, and with reference to FIGS. 3A and 3B, a complete transaction authorization process 300 is shown according to an embodiment. Although certain steps of the transaction authorization process will be described, it is appreciated that they are for exemplary purposes only and that different steps and/or different combinations of steps can be provided in other embodiments.

In the present embodiment, the process 300 starts by receiving an authorization request 301 at the virtual issuer. In the present embodiment, the authorization request is received from an issuing partner that handles communications over credit card networks through which the virtual credit card is issued (such as Visa, Mastercard, AMEX, etc.) The authorization request includes various transaction information, including CCN/Token, card expiry, the merchant name (descriptor), ID, MCC, the merchant's country, currency code, amount, AVS package, CVV check, fraud score, etc. It is appreciated that other transaction information can be provided, including any information that allows processing the transaction and/or any information that can be used to assist in validating the request and/or deciding whether or not the transaction should be approved or denied.

Once the authorization request is received, various steps of transaction authorization logic can be carried out by the virtual issuer, for example using data stored in a virtual card information database 108 that can be stored on the virtual issuer server or accessible thereto. The authorization logic can be carried out on the virtual issuer server, and/or on an external server such as a third-party advisor server. By way of example, the authorization logic steps can include:
determining whether the card exists in the virtual issuer's records 303 (for example if card information is stored in database 108);
determining whether the card is in a valid state 305 (for example if the user's account is in a valid status, if Know Your Customer (KYC) and Anti-money laundering (AML) status is valid if the user is verified, if the funding source is good and/or verified, if the user limits have not been exceeded, etc.);
determining whether the card is a subscription card 307, and if so whether the subscription is active 308; and
determining whether additional verifications pass 309, including a velocity check (user & issuer card level), a fraud analysis (internal and/or external verification), a verification of whether the amount to be charged is authorized (ex: corresponds to an expected amount and/or not over a specified limit, for example as defined in client preferences for the card), a verification of whether transactions from the requesting merchant are authorized on the card (for example based on the merchant ID), etc.

It is appreciated that other verifications can be done as well using the transaction information and/or any other data available relating to the client, merchant, transaction context, etc. If the verifications described above fail, the virtual issuer can decline the transaction outright by sending a decline message to the issuing partner 347, which can be ultimately forwarded back to the merchant.

In some embodiments, authorization can proceed through the origin issuer only if all the verifications pass. In other embodiments, authorization can proceed through the origin issuer in parallel with the verifications, for example prior to some or all of the verifications being completed. In both cases, a subsequent step can comprise checking the funding source 311. The subsequent steps will be described in connection with a funding source corresponding to a credit card funding source. It is appreciated that similar steps can be carried out for other types of funding sources such as Automated Clearing House (ACH) payments.

If the funding source is a credit card, a subsequent step can comprise determining whether the card can be charged 313. This determination can be made based on various information relating to the credit card, for example if the card is expired, if the bank identification number (BIN) is blocked, etc. If it is determined that the card cannot be charged, the virtual issuer can decline the transaction by sending a decline message to the issuing partner 347.

If it is determined that the card can be charged, a subsequent step can comprise passing through a foreign exchange module (forex) to determine the issuing country/region of the card to forward the transaction to the appropriate acquiring partner (virtual acquirer) and/or to process the transaction in the appropriate currency. For example, this can involve determining whether the card is a Canadian card 315, a US card 317, or a European card 319, and sending a transaction authorization request to the origin issuer through the appropriate Canadian 321, US 323 or European 325 acquiring partner. When sending the transaction authorization request to the appropriate acquiring partner, the descriptor that is used in the transaction authorization request can correspond to the enhanced descriptor that is generated according to the method that was described hereinabove.

Upon receipt of the transaction authorization request, the origin issuer can carry out its own logic to determine whether the transaction should be approved and send a corresponding response back to the virtual issuer through the acquiring partner. Upon receiving a response, a subsequent step can involve processing the response to determine whether the transaction has been approved by the origin issuer. If the transaction is declined by the origin issuer, the failed transaction can be logged by the virtual issuer 329, for example in the transaction database 109, and the virtual issuer can send a decline message to the issuing partner 347.

As mentioned above, when sending a transaction authorization request, there can be a defined limit of 5 seconds in which a response must be received. If this 5 second limit is exceeded 331, the authorization process can be released 333, the transaction can be logged as a failed transaction 335 in the transaction database 109, and the virtual issuer can send a decline message to the issuing partner 347.

If the transaction is approved and the response is received within the 5 second limit, the transaction can be logged as an authorized transaction 337 in the transaction database 109, and an approval message can subsequently be sent to the issuing partner 339. Although the transaction has now been authorized by the virtual issuer, it should be appreciated that the issuing partner and/or merchant acquirer can be running their own authorization logic and may refuse the transaction on their end. If the issuer authorization has failed (for example if the virtual issuer took too long to respond, if fraud detection failed by the issuer, etc.) the authorization process can be released 333 the transaction can be logged as a failed transaction 335 in the transaction database 109, and the virtual issuer can send a decline message to the issuing partner 347. However, if the issuer authorization is successful, the transaction can be logged as a successful transaction 343 in the transaction database 109 (for example in association with the origin transaction), and the user can be notified that the transaction is successful 345. It should be appreciated that the client/user can be notified via the merchant, merchant acquirer, issuing partner etc., and/or can be notified directly by the virtual issuer, for example via a dedicated software application on the client device that is provided by the virtual issuer, or via another communication channel with the client and/or client device.

As can be appreciated, the above-described systems and methods can be particularly advantageous because they allow for a user to ultimately choose what descriptors will appear on their statements. In this fashion, the descriptors described herein can be referred to as cardholder-defined or cardholder-controllable charge descriptors. Such functionality is enabled at least in part by the three-party system described above which involves a merchant server, a virtual issuer server, and an origin issuer server. The virtual issuer server, acting as an intermediary, allows for descriptors to be controlled by users in a way that would not otherwise be possible in traditional two-party systems involving a merchant server and an origin issuer server, where the merchant defines the content of the charge descriptor. In the three-party system, the virtual issuer server can effectively overwrite a charge descriptor provided by a merchant server, thus allowing charge descriptors to be customized and controlled irrespective of what is initially provided by the merchant server. The methods described above further allow overcoming challenges that are specific to the three-party system, in that a charge descriptor can be overridden and a charge can be successfully processed within a single predefined time limit imposed by a payment network or issuing partner associated with the virtual issuer, even though the transaction must pass twice through a payment network or issuing partner for authorization (i.e. once via a payment network associated with the virtual issuer, and once via a payment network associated with the origin issuer).

In the foregoing specification, specific embodiments have been described. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “computing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

As used herein, a machine may refer to a server, processor, or other suitable computing device. For example, a “virtual machine” may refer to a virtual server, virtual issue server, or the like. Further, an action will be understood to mean any suitable action, including, but not limited to an electronic transaction (payment or otherwise). An instrument may refer to a card, such as a credit, debit, or other payment card, which may be physical or virtual, or any other payment method (electronic or otherwise). Memory may include any suitable computing memory and/or databases (including those discussed below and herein).

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. A process for enhanced descriptors via virtual machines comprising:
upon receipt of a first request relating to authorization of an action on a virtual instrument and comprising a first descriptor, computing, by a virtual machine, client preferences linked with the virtual instrument;
generating, by the virtual machine, a second descriptor that is different than the first descriptor, the second descriptor generated based at least in part on the client preferences; and
transmitting, by the virtual machine, a second request relating to authorization of the action on an origin instrument linked with the virtual instrument and comprising the second descriptor.

2. The process for enhanced descriptors via virtual machines according to claim 1, comprising:
receiving, by the virtual machine, received client preferences from a device, the received client preferences setting descriptor control logic to link with the virtual instrument; and
linking the received client preferences with the virtual instrument in a client preferences memory.

3. The process for enhanced descriptors according to claim 2, comprising:
receiving, by the virtual machine, a request from the device to adapt the received client preferences linked with the virtual instrument to define new descriptor logic; and
adapting the received client preferences in the client preferences memory to use the new descriptor logic.

4. The process for enhanced descriptors according to claim 2, wherein the first request comprises an instrument number, and computing client preferences comprises identifying the received client preferences linked with the instrument number in the client preferences memory.

5. The process for enhanced descriptors according to claim 1, comprising:
receiving, by the virtual machine, a request from a device to generate the virtual instrument linked with the origin instrument, the request including client preferences delineating descriptor logic;
generating, by the virtual machine, a unique instrument number for the virtual instrument;
storing the unique instrument number in a virtual instrument information memory linked with the origin instrument; and
storing the received client preferences in a client preferences memory linked with the virtual instrument.

6. The process for enhanced descriptors according to claim 1, comprising storing, by the virtual machine, an indication of the first request in a memory, the indication of the first request comprising at least the first descriptor.

7. The process for enhanced descriptors according to claim 6, further comprising storing, by the virtual machine, an indication of the second request, the indication of the second request comprising at least the second descriptor and the indication of the first request.

8. The process for enhanced descriptors according to claim 1, wherein the client preferences delineate descriptor control logic to be applied to a specified action type, the process further comprising computing whether the first request relates to the specified action type, and generating the second descriptor using the descriptor control logic if the first request relates to the specified action type.

9. The process for enhanced descriptors according to claim 8, further comprising generating the second descriptor using predefined default descriptor logic if the first request does not relate to the specified action type.

10. The process for enhanced descriptors according to claim 8, wherein the client preferences delineate at least first descriptor control logic linked with a first action type and a second descriptor control logic linked with a second action type, the process further comprising determining whether the first request relates to the first action type or the second action type and generating the second descriptor using the descriptor control logic linked with the computed action type.

11. The process for enhanced descriptors according to claim 1, wherein the descriptor logic comprises a predefined string, further wherein the second descriptor is generated to include the predefined string.

12. The process for enhanced descriptors according to claim 11, wherein the predefined string is received from a device when computing the client preferences.

13. The process for enhanced descriptors according to claim 11, wherein:
the predefined string comprises variables; and
upon generation of the second descriptor the predefined string variables are replaced.

14. The process for enhanced descriptors according to claim 1, comprising generating a unique action identifier, wherein the second descriptor is generated to include the predefined string.

15. The process for enhanced descriptors according to claim 1, wherein generating the second descriptor comprises prepending, appending or inserting additional characters into the first descriptor.

16. The process for enhanced descriptors according to claim 1, comprising authenticating the request relating to authorization of the action on the virtual instrument using authorization logic, and transmitting the second request relating to authorization of the action on the origin instrument if the request relating to authorization of the action on the virtual instrument is successfully authenticated.

17. A system for enhanced descriptors comprising a virtual machine configured to:
upon receipt of a first request relating to authorization of an action on a virtual instrument, the first request comprising a first descriptor, compute client preferences linked with the virtual instrument;
generate a second descriptor that is different than the first descriptor, the second descriptor being generated using descriptor control logic defined in the client preferences; and
transmit a second request relating to authorization of the action on an origin instrument linked with the virtual instrument, the second request comprising the second descriptor.
